(19) United States
(12) Patent Application Publication
(10) Pub. No.: US 2014/0324501 A1
(43) Pub. Date: Oct. 30, 2014

(54) METHOD AND SYSTEM FOR AUTOMATED TEMPLATE CREATION AND ROLLUP

(71) Applicant: The Glassbox Incorporated, Glen Head, NY (US)

(72) Inventors: Dorothy Young DAVIDOW, Glen Head, NY (US); Richard J. LEVINSON, Larchmont, NY (US); Paul A. Sciandra, Cumming, GA (US); Ramkaran RUDRAVARAM, Hyderabad (IN)

(73) Assignee: The Glassbox Incorporated, Glen Head, NY (US)

(21) Appl. No.: 14/266,648

(22) Filed: Apr. 30, 2014

Related U.S. Application Data
(60) Provisional application No. 61/817,809, filed on Apr. 30, 2013.

(51) Int. Cl. G06Q 10/06

(52) U.S. Cl. CPC G06Q 10/063118
USPC 705/7.17

(57) ABSTRACT

A method and system is provided for customizing a template used to accumulate data from a plurality of responders. A template may be generated that is customized according a plurality of user-selected template parameters including: a layout of the template indicating a number of rows and/or columns of template fields and a data type for each field selected from a plurality of data types in the group consisting of: text, number, date, text list, number list, date list, constant value, link to another field and formula. Each template is associated with a question that may be assigned to one or more responders or a shared group of responders. Unstructured data may be received from responders in response to the question and may be converted to structured data having the data type selected for the template field(s) associated with the question. The template field may be populated with the converted structured data. The structured responses are collected into the customized template and “rolled-up” or aggregated into a system consolidated template. The data collected may be used to generate a report, for example, to be evaluated by executives or personnel overseeing a project.

### FIELD OF THE INVENTION

The invention relates to a system and method of creating a flexible or ad hoc template for collecting data from a plurality of users, which data may be data collected and used to generate a report.

### BACKGROUND OF THE INVENTION

Project managers typically have a responsibility to oversee large numbers of personnel, manage their progress and coordinate their responsibilities. However, communication with large groups can quickly become unmanageable. For example, a simple question to all members working on a project can prompt hundreds of emails, each of which must be manually reviewed and analyzed. If the question involves a spreadsheet, template or collection of data, each response must be consolidated manually.

To solve this problem, systems have been developed that automate “recurring or fixed” data collection, for example, by sending a survey to respondents and automatically analyzing the responses, e.g., by performing statistical analysis. However, in order to automatically analyze responses from multiple users, the responses must be in the same format from all respondents. Accordingly, such systems restrict survey design to rigid formats, such as, number fields or check boxes or other “closed-ended” questions, thereby limiting responders to choose from among only preset options.

When the closed-ended templates are not robust or detailed enough to gather the information needed, and there is not the time available to hard code/prepare a new rigid template, sistribute it to the respondents, and gather and consolidate their responses, a manual spreadsheet will typically be attached to the question response or a separate one e-mailed. These responses to these spreadsheets or templates must then be manually consolidated.

In addition, since “closed-ended” questions typically provide only superficial information, surveys often supplement these questions with “open-ended” questions wherein the respondent may freely enter text without restriction. Open-ended questions often ask a respondent to “comment” or to provide an attachment. However, open-ended responses are handled separately and differently from closed-ended responses. Open-ended responses cannot be consolidated or analyzed together since they lack uniformity. Typically, reports will list “comments” separately from other consolidated statistical data. Accordingly, project managers must review open-ended responses manually, a prohibitively time-consuming task for managing large numbers of personnel.

There is, therefore, a great need for a flexible question and template structure that incorporates, automatically consolidates, and analyzes responses to both closed-ended and open-ended questions.

Accordingly, there is now provided with this invention an improved method for effectively overcoming the aforementioned difficulties and longstanding problems inherent in the art.

### SUMMARY OF THE INVENTION

Embodiments of the invention relate to a system and method of creating a flexible or ad hoc template for collecting data from a plurality of users, such as employees in a company, members on a project team or external responders, by providing a questionnaire with embedded templates to collect responses. Questions or requests for data may be sent out to the users, and their responses are collected in the embedded template and are then “rolled-up” or aggregated into a system consolidated template. The data collected may be used to generate a report, for example, to be evaluated by executives or personnel overseeing a project.

According to an embodiment of the invention, there is provided a system and method for customizing a template used to accumulate data from a plurality of responders. A template may be generated that is customized according to the needs of the project manager from a plurality of user-selected template parameters including: a layout of the template indicating a number of rows and/or columns of template fields and a data type for each field selected from a plurality of data types in the group consisting of: text, number, date, text list, number list, date list, constant value, link to another field and formula. In addition to the data type selected for each field, there are additional field data controls that may be selected including: number of characters, currency, high/low, fixed, recurring, and format.

Each template will be associated with a question for which the Project Manager will clearly lay out the instructions as to what is expected from the responders. Each question may be assigned to one or more responders. Data is received from responders in response to the question via manually inserting the data into the template or uploading it from storage, e.g., via an Excel spreadsheet. The data that is input by the responders is based on the data type selected by the Project Manager for each of the template field(s). The Responders' template data is written to the system database, is verified against the template data field requirements and is made available for consolidation or reporting.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for creating and using customized templates according to an embodiment of the invention;

FIG. 2 schematically illustrates a workflow for creating and using customized templates according to an embodiment of the invention;

FIG. 3 schematically illustrates data structures used to populate a customized template according to an embodiment of the invention;

FIG. 4 schematically illustrates a workflow for creating locking a customized template from edit according to an embodiment of the invention;

FIG. 5 is a diagram showing the organization of individual responders into groups according to an embodiment of the invention;

FIGS. 6A-6C schematically illustrate a workflow for creating and using customized templates according to an embodiment of the invention; and

FIGS. 7-13 show examples of user-interfaces for customizing a template according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may provide a method and system for a user, such as a project manager, to generate customized templates for accumulating, aggregating or clustering data from a plurality of responders. Templates may be linked to a plurality of questions or tasks that prompt responders to submit responses. The responses may be received at a centralized data collection unit and processed to convert unstructured or “open-ended” user-generated responses into structured data of a uniform format pre-designated for each template field.

Templates may be customized according to selections received from the project manager designating a plurality of variable template parameters. These variable template parameters provide a palette of core fields that represent a controlled vocabulary for the template. Each of these variable template parameters introduces a new degree of freedom to the template creation process to increase the flexibility and options of the templates so that templates may be customized according to each project manager's needs. Variable template parameters may be selected from the group consisting of:
Data structure: The user may select a single data structure or toggle between multiple data structures, each retrieving data from the same memory location(s) but presenting the data in their different respective formats, e.g., table, spreadsheet, list, memory buffer, matrix or any other data structure.
Layout: The Layout option enables the project manager to select the dimensions of the template by indicating a number of rows (m) and/or columns (n) of template fields, e.g., a horizontal row of template fields (a row vector of dimension m×1), a vertical column of template fields (a column vector of dimension 1×n), or a two-dimensional array including multiple rows and multiple columns of template fields (a matrix of dimension m×n).
Consolidated Behavior: Upon creation of a physical consolidated template of responses, a ‘consolidated’ tab may be created that ‘stacks’ the answers provided by individual users into one worksheet, e.g., stack responses from top to bottom or left to right. This ‘stacked’ view of all the responses may then be sorted and summarized as needed by the project manager or may be accessed from the systems embedded reporting tool.
Field Data Type: e.g., text, number, date, text list, number list, date list, constant value, link to another value, formula, image and/or embedded value.
Numeric Field Attributes: e.g., number of decimal places, sub-total, average, minimum, maximum.
Formula Functions: e.g., median, average, mode, smallest, largest, standard deviation.
Formula Operators: e.g., Addition, subtraction, multiplication, division, power, square root, absolute value.
Field Value Validation Rules: e.g., Value range, invalid format, special character controls, blank/null controls.
Input Type: e.g., direct user input, computed user input, or pre-filled.
Mandatory response: Templates and/or questions designated as mandatory. For example, all responses to questions designated as mandatory must be received in order for the consolidated template or project to be considered compliant or complete. Mandatory templates or questions may be handled with a different set of rules than non-mandatory templates or questions. For example, in one embodiment, a roject Manager may not be permitted to submit any final consolidated responses until all requested mandatory questions are submitted by the responder and approved.
In one embodiment, a project manager can determine that a response must be received from every responder in order for the consolidated template to be considered complete. For example, a Global Cost Proposal in which every local office's costs must be accounted for in order for the total to be accurate. The system will not allow the template to be finalized or consolidated if one or more of the mandatory responses is missing, and an appropriate error message will be displayed.
Assignment to responders: Each template may be linked via a question assigned to a group or individual responder. Assignment to group or individual responders enables each template and its linked question to be assigned to a single individual responder, a group of responders submitting individually, and/or a group of responders submitting a shared response.
Recurring or Rolling Template, a periodic or rolling reporting option may be used for each new report where the previous period's template, assignments, and related responses are duplicated and available for update by the appropriate responder.
Delegate: A user assigned to a question may ‘delegate’ another user to answer the question, e.g., due to availability constraints or lack of domain expertise, e.g., yes or no.

Templates may define an underlying data structure for storing responder submissions, such as, a table or spreadsheet. The template may initially be empty, but may be filled over time with respondent data submissions. Templates may be fully configurable so that each row (or column) of the template may define an independent type of information and each column (or row) may define an independent individual or group of responders. Each template may be created as an original document from scratch or may be modified from a previously saved template.

Once the templates are generated, questions or tasks are linked to those templates, and the questions are assigned to a plurality of responders to prompt the responders to enter information into each of the template fields according to its data type. For example, a template with fields related to reporting staff work activity may be linked to a question “What level tasks and effort did each staff member perform this month?”

According to some embodiments of the invention, a template or template fields may be locked from being edited, deleted or modified in any way, when they are linked to a question. The locking preserves data integrity by preventing any changes to an active template. In one embodiment, a questionnaire with a question linked to a template must be assigned to a responder(s) in order to activate the template, collect data, and implement the locking feature.

Questions or tasks may be assigned to individual responders or to one or more groups of responders, for example, selected based on the group's pre-designated profile parameters, such as, location (e.g., region, country, time zone, etc.), structure (e.g., office, team, organization, etc.), available work hours, etc. Questions may be assigned fully-automatically, e.g., where questions and responders are each associated with respective descriptive parameters (e.g., field of focus, experience level, familiarity with a project, etc.) and a processor matches questions to responders associated with the closest respective parameters. Questions may alternatively be assigned semi-automatically where the processor may filter available responders to a selected or preset number with closest matching parameters, but where the ultimate assignment is made by the project manager. Alternatively, questions may be assigned fully manually, e.g., by the project manager.

Responders may submit responses to the questions into user-interface fields of a questionnaire as “unstructured” data. The unstructured data may be automatically converted and entered into the linked template fields as “structured” data. Unstructured data includes, for example, data that may be freely entered by a responder without restricting entry to a specific format, syntax or type of data. Structured data includes, for example, restricted fields, such as, a specific format or data type including text fields or number fields, e.g., date fields of the form mo/da/year, or words in a specific syntax, etc.

In order to convert unstructured responses to structured data, in one embodiment of the invention, an unstructured response entered into the user-interface field may be automatically converted to structured data of the format and type associated with that template field. For example, data entered into a field associated with a specific syntax form (e.g., 01/11/1983) may be automatically converted from any other form (e.g., Jan. 11, 1983, 1-11-83, 01-11-83 or 11-1-83) to that form (e.g., 01/11/1983).

In another embodiment of the invention, structured data may be automatically identified in unstructured responses, e.g., by textual recognition analysis. A textual recognition analysis module may search unstructured responses for data having a format or type that matches that of the structured data field associated to the template field. In one example, in order to populate a structured data field in a template field that represents a number of hours spent on a project, the textual recognition analysis engine may search each responder's unstructured response for a number, check if the number is within a predetermined threshold range (e.g., 0.01-50) indicating a reasonable likelihood that the number is associated with the field data and, if the number falls within the predetermined threshold range, the data may be used to populate the template field as structured data. The respondent entries may be stored in the template field as unprocessed data or may further process the respondent entries. For example, a number entered by the responder may be rounded to an integer or be converted according to a formula or equation, for example, to conform the data to the specific format or data type of the structured template field (e.g., converting a decimal fraction such as 8.123 to an integer such as 8).

In another embodiment of the invention, when the data entered in response to a question is not in the structured format predefined for the linked template field, an error message may be sent, requesting that the responder re-enter the data in an appropriate format.

The process of extracting unstructured responses to questions and converting them to structured data for storage in the template may be referred to as a template “roll-up.” The roll-up process may be initiated manually (e.g., by a project manager selecting a “roll-up” field on a user-interface), or automatically, such as, each time new responders submit answers or periodically such as annually, monthly, weekly or in real-time (e.g., every several minutes or seconds). Periodic or repeated roll-up may provide respondent data or reports on a rolling or continual basis.

In some embodiments, the template may incorporate images, charts, links, icons, and other non-alphanumeric data. For example, when responses include a non-alphanumeric data object, the non-alphanumeric data object may be embedded into the template. For example, the data object may be displayed in the associated template field or the field may include a link to the image, which may be selected to display the image. In addition to previous embodiments that increased responder flexibility by allowing responders to submit unstructured data, this embodiment allows responders to also submit non-alphanumeric data, which further increases such flexibility.

In one embodiment, respondents may view only questions with templates to which they have been assigned by the Project Manager. For security purposes, a responder will not have access to other questions or templates to which they have not been assigned. In this way, projects with multiple questions with various templates may be personalized to the associated responder(s) so as to ask only for information that the responder is qualified to provide.

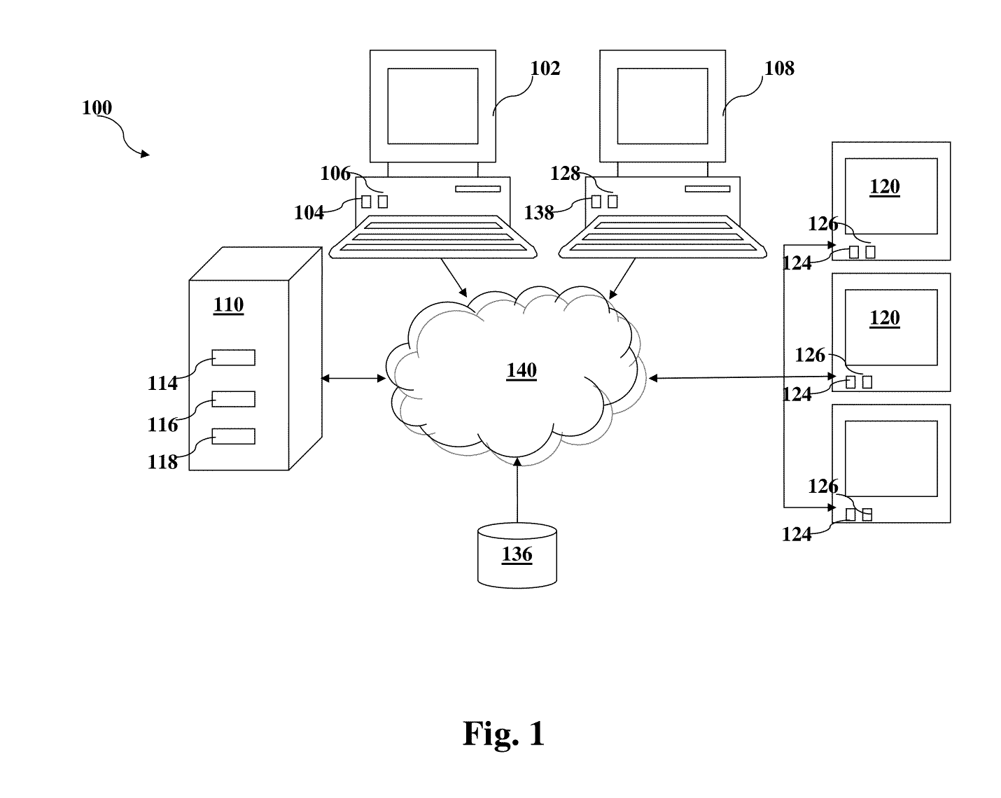

Reference is made to FIG. 1, which schematically illustrates a system 100 for creating and using customized templates according to an embodiment of the invention. System 100 may include one or more computer(s) 102 each operated by a project manager connected to a plurality of computers 120 each operated by a respective individual responder.

A server 110 may provide project manager computer(s) 102 with an application for creating a template to accumulate data from the plurality of responder computers 120. The template may be customized by project manager computer(s) 102 selecting values or states for a plurality of variable template parameters. The template may be configured to have a user-selected data structure, such as, spreadsheet, table, etc., and a layout or dimension, for example, defined by a number of user-selected rows and/or columns. The template may have a one-dimensional horizontal or vertical layout (e.g., a m×1 column vector or a 1×n row vector) or may have a two-dimensional layout (e.g., a m×n matrix).

Each field of the template may also be customized according to user-selected parameter values. Each template field may be configured to represent data of a designated structure or data type, such as, text, number, date, text list, number list, date list, constant value, link to another field, formula or non-alphanumeric data object. Formula fields may be configured to compute a mathematical output from one or more input fields. For example, a formula may be a median, average, mode, smallest, largest, or other formula, and may be composed of formula operators, such as addition, subtraction, multiplication, division, power, square root, absolute value, etc. Template fields may be configured according to a predefined list of values, such as Y or N (for yes/no questions), numbers with a predefined number of decimal places, date formats such as 01-11-1983, etc. Each template question may be configured to represent data collected from a single responder computer 120 as an “individual” responder or a plurality of responder computers 120 as a “group” of individual responders or as a ‘collaborative group’ that shares one reponse. ‘Collaborative group’ responders share one copy of the row or rows of data entered for each field as a single answer. A single member of the group may submit the ‘final’ answer that represents all the contributions of the group members.

Input into each template field is mandatory and must comply with the field format defined in the template. The responder may save a template without all the mandatory fields completed or with errors. The system will highlight errors and provide a relevant message. For example, if a responder does not have all the required information but wants to save his/her input to date, the responder may choose not to submit the template until all required fields are completed and system verified. Upon successful submission to the Project Manager, a success message is displayed. The customization settings or values selected by project manager computer(s) 102 may be stored in a server-side memory, e.g., memory 114 or database 136 or a client-side memory e.g. memory 104.

Questions, template fields, responders and the associations therebetween may be stored in a server-side memory, e.g., memory 114 or database 136 or a client-side memory, e.g., memory 104. Server 110 or project manager computer(s) 102 may send (or initiate sending) each responder computer 120 questions assigned thereto.

In order to increase response flexibility, server 110 may accept responses that include unstructured data submitted by responder computers 120. Unstructured data may include alphanumeric data or, in some embodiments, non-alphanumeric data, which is not formatted according to the data type predefined for the associated template field. For unstructured alphanumeric responses, responders can freely enter data of one data type (e.g., text) or format (e.g., Jan. 11, 1983) in response to questions linked to fields associated with a different data type (e.g., numeric) or format (e.g., 01-11-1983). Server 110 may convert the unstructured data to the structured data type and format pre-defined for the template field. Server 110 may include an analysis engine 118, which may execute a “fuzzy” or similar/inexact search to identify information in the response relevant to the structured data type or format of the template field. For example, analysis engine 118 may identify an unstructured term such as “January,” which may not have the predefined format or data type “01” of the structured field, as related and may convert that unstructured data to the structured data type and format predefined for the field.

In order to further increase response flexibility, in some embodiments, server 110 may accept non-alphanumeric responses. In one embodiment, image data may be embedded into the template as an image or a link thereto. In another embodiment, analysis engine 118 may include image recognition capabilities to identify and extract alphanumeric information from the image object and to represent the extracted alphanumeric information in the template field as the structured data type and format predefined for that field.

Responses submitted by responder computers 120 may populate the template automatically only after being approved by project manager computer 102.

Once populated, project manager computer 102 may select to export the individually submitted responder data or the consolidated data from multiple responders from the template into a report. Server 110 may also generate a report from the template data. For example, analysis engine 118 may consolidate template fields, perform a statistical analysis on the template field data, generate charts or diagrams, etc. The template, questions and/or reports may be sent from server 110 or project manager computer 102, to a computer 108, e.g., operated by an executive.

Project manager computer 102, executive computer 108, responder computers 120, server 110 and database 136 may connect and transmit data via a network 140, which may be any wired or wireless network, such as the Internet or World Wide Web, radio or telephone network.

Each project manager computer 102, executive computer 108, responder computer 120 and server 110 may include one or more processor(s) 106, 138, 126, 116, respectively, to perform operations executed according to embodiments of the invention and one or more memories 104, 128, 124, 114, respectively, to store data generated according to embodiments of the invention.

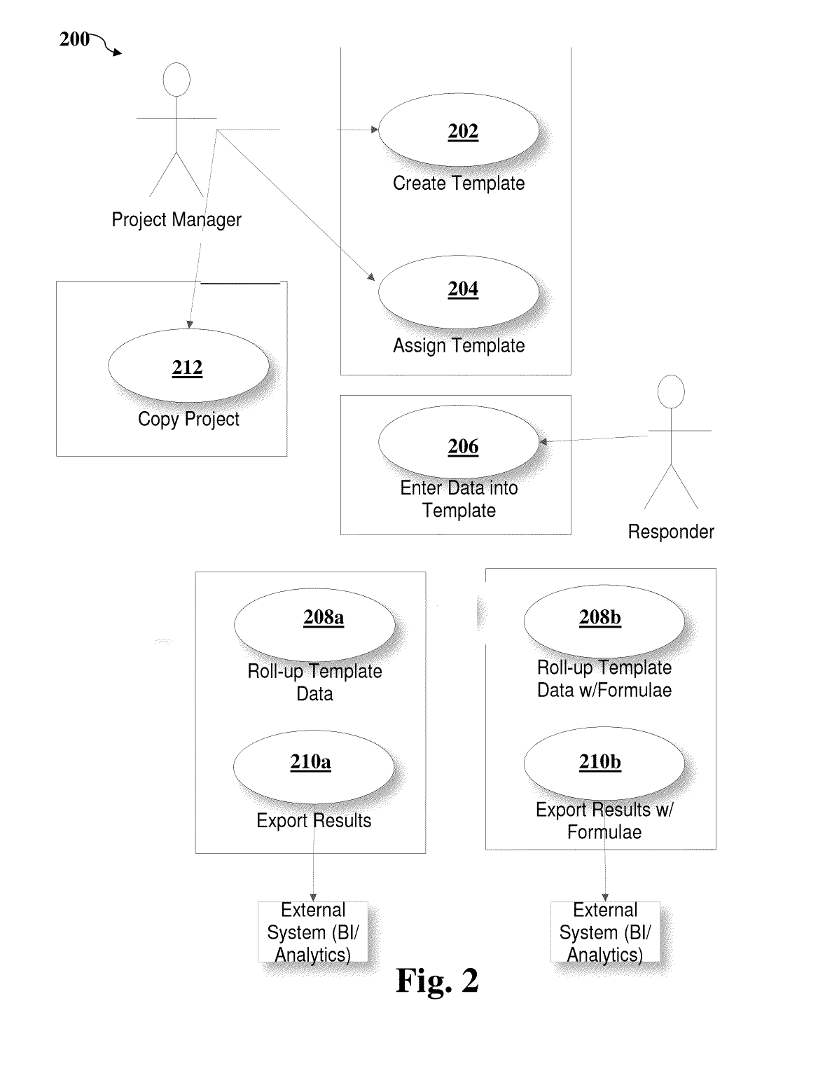

Reference is made to FIG. 2, which schematically illustrates a workflow 200 for creating and using customized templates according to an embodiment of the invention. The method of FIG. 2 may be executed using the devices of FIG. 1. For example, an executive may operate computer 108 of FIG. 1, a project manager may operate computer 102 of FIG. 1 and a plurality of responders may each operate a plurality of computers 120 of FIG. 1 to implement workflow 200. The template creation and usage workflow 200 may include operations, e.g., executed by server 110 of FIG. 1, such as creating a template 202, assigning template questions to individual or groups of responders 204, receiving data submission from the assigned responders 206, rollup responses into the template 208, exporting the template data to generate a report 210, and/or copying the template (operations 202-204) for use in another project 212. These operations are described in greater detail as follows.

Create a template 202: Embodiments of the invention may provide a set of core parameters that represent a controlled vocabulary for generating and modifying templates. Templates may be customized by selecting settings from this set of core parameters, e.g., to create templates designed to address particular problems or questions posed by executives. In one embodiment, this centrally controlled vocabulary approach enforces an enterprise-wide (or vertical-wide) semantic vocabulary of the core parameters. In one example, embodiments of the invention may connect expert responders (potentially using other enterprise systems) providing input and other enterprise systems receiving output.

Assign the template 204: Each template may be assigned and completed in order to answer the question associated with this Template. Each template may be associated with a question to prompt a responder to submit data for entry into the template field. Each template type question may be assigned to an individual or group of responders. Responders may be searched for or categorized in groups based on region, e.g., city, state or country. Responders may be assigned manually by the project manager, automatically as the best ranking responders, e.g., in total or for a specific category per question, or semi-automatically where the processor automatically selects a sub-set of the available responders (e.g., the best ranking responders, responders that scored or qualified above a threshold rating in that relevant question category, or responders that are in time zones that are “available,” e.g., within office hours, when submissions are needed) and the project manager manually selects the final responders from among the users in that sub-set. In some embodiments, “available responders” may include all personnel in a team, company, or other group, a sub-set of responders who are not assigned to other work, a sub-set of responders having a cumulative amount of assigned work that is less than a maximum work load for that responder, and/or a sub-set of responders who have been assigned work of lesser priority than that of the current project.

Receive template responses 206: The assigned responders may submit answers to the questions (e.g., via computers 120 of FIG. 1) that are received by a centralized unit (e.g., server 110 of FIG. 1) and stored in a centralized or server-side memory (e.g., memory 114 or database 136 of FIG. 1). In one example, a responder enters data into fields of a user-interface. After entering the data (e.g., including data for all fields designated as mandatory), the responder may save the data and/or submit the data to the centralized unit, where the data is available for aggregation across all the responder's inputs. The responses may be sent from the database to the project manager (e.g., via computers 102 of FIG. 1) either automatically, e.g. for mandatory review, or only when the project manager requests to review the responses.

Rollup template data 208a: The system may incorporate the responses from the individual responder templates into the consolidated roll-up template, for example, according to the predefined template rules or parameters. Each response may be associated with a question and a responder (the individual user submitting the response). Unstructured data in the responses may be converted to structured data, for example, according to the data type, format, syntax, etc., predefined for each field. Rollup template data 208b includes the rollup of template data including one or more formulae.

Export template data 210: The template may be exported to generate a report, for example, for use by external, target systems. Reports may be customized according to user-selections of report parameters, such as, one or more source(s) of data used for the report (e.g., for joining tables or questionnaires generated by multiple individual or groups of responders), one or more field(s) displayed in the report such as users/responders or activity time or type, summary of the data, charts to display the data, gauges allowing a user to select parameters for the display of the report (e.g., sort, minimum values, maximum values, etc.) as well as a ‘gauge’ graphic style (e.g., dial or linear), a style for the report (e.g., an original design or a design selected from among pre-designed report style templates), filters to filter the template data, additional ‘derived’ fields created by using math or string functions, and an option to preview a report generated according to those parameters.

Reports are generally created by a project manager for an executive, but may be generated by and for any user. After reviewing the report, the project manager or executive may decide he would like to view other data and may modify the template parameters or report parameters. In one embodiment, modifications to a template or report by a superior in an organizational hierarchy (e.g., an executive) may override template settings selected by an inferior (e.g., project manager), but not vice versa. Export template data 210b exports template data including one or more formulae.

Copy project 212: A new project may be generated either by re-using a question and template or by populating template parameters with values used in a previous project. In one embodiment, a project manager may manually select to copy an existing template into a new project. In another embodiment, all the elements of an existing project may be automatically copied into a new project by a processor (e.g., server processor 116 of FIG. 1), for example, periodically or at a scheduled date/time. The question, template, assignments and previously submitted data is all copied and rolled forward for update. For example, globally collected pipeline (new business) data that represents the state of new business potential at the end of the last period can populate the beginning of the current or next period. This is particularly useful since it eliminates what could be tedious, time-consuming, labor-intensive data entry, potentially thousands of entries. In one embodiment, export data may be saved in the system in two states, “saved” (pre-approved) and “submitted” (approved and submitted for inclusion in automated template rollup). This data may be used to initialize a new project. This copy project function may incrementally copy data for each question-answer-template group in the “copy from” project to the “copy to” project. Only the “submitted” states associated with the template may be stored with the “copy to” project.

Other or different workflow operations may also be used.

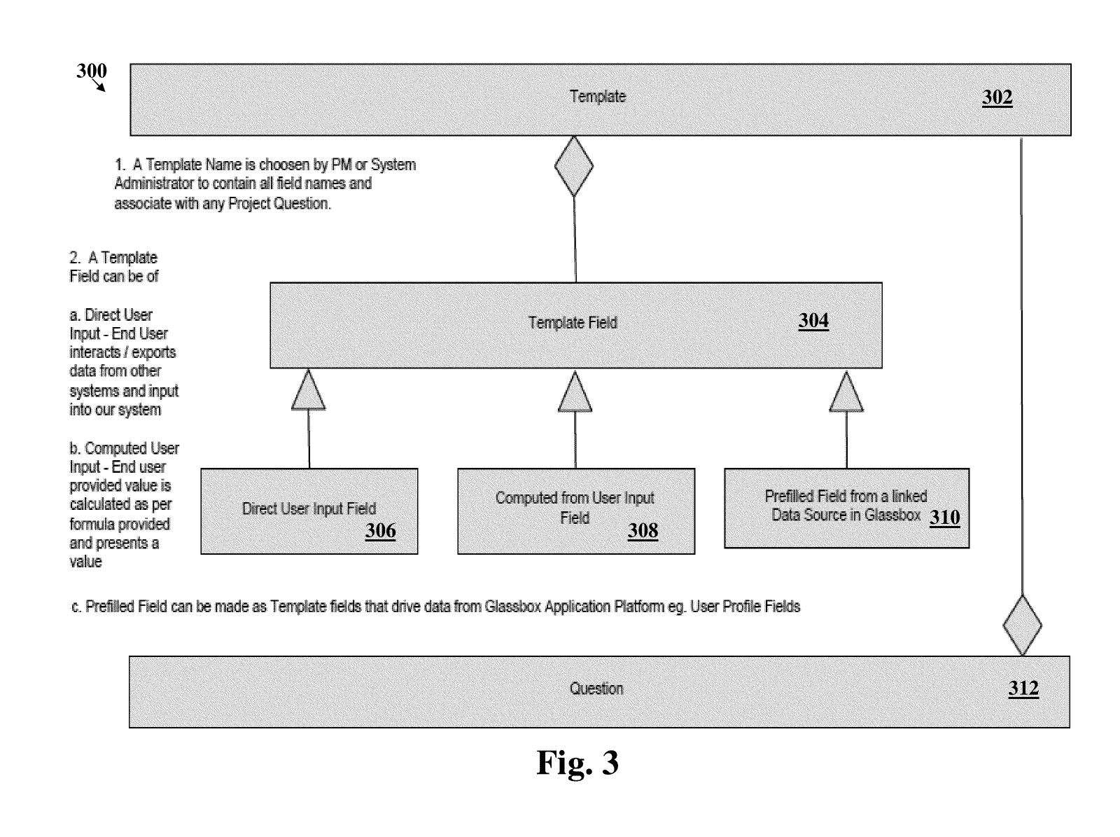

Reference is made to FIG. 3, which schematically illustrates data structures 300 used to populate a customized template 302 according to an embodiment of the invention.

Template 302 may be generated, for example, according to the method described in reference to FIG. 2 and/or using the system described in reference to FIG. 1.

Template 302 may include a plurality of fields 304 for representing data submitted by responders. Data may be entered into template fields 304 according to a customized input type, e.g., a pre-designated input type parameter. The input types may include, for example, a direct user input 306, a computed user input 308, or a pre-filled input 310.

Direct user input 306 includes data provided by an end user (e.g., responder) that submits or exports data from an external device (e.g., responder computers 120 of FIG. 1) to a centralized system unit (e.g., server 110 of FIG. 1), e.g., via a wireless connection (e.g., over network 140 of FIG. 1).

Computed user input 308 includes data that is computed by the system, for example, according to a formula or algorithm, from user provided input. Computed user input 308 is generally associated with formula fields. Computed user input 308 may input user-generated data, e.g., direct user input 306 from other fields, and may output computed values.

Pre-filled input 310 includes system-generated or copied data automatically filled into template fields. Pre-filled input 310 is generally not derived form any user-input. Pre-filled input 310 may automatically input data from an application, such as user-profile fields, user-evaluation fields, time of entry fields, or other statistics generated by the system, from memories (e.g., memories 104, 128, 124 and/or 114 of FIG. 1), e.g., or from previous templates (e.g., extracted from a copied project).

Each one-dimensional template or row/column in a two-dimensional template may be associated with a single question 312. Question 312 may prompt responders to submit responses, e.g., for direct user input 306 template fields and some computed user input 308. Pre-filled input 310 fields and some computed user input 308 may not be associated with questions, since they may not independently depend on user-generated data. Pre-filled data may be, for example, a user's city and country, extracted from the users profile, and may be automatically provided as part of the answer to the question to reduce repetitive data entry of the same values. In other embodiments, pre-filled input 310 fields and some computed user input 308 may be associated with questions.

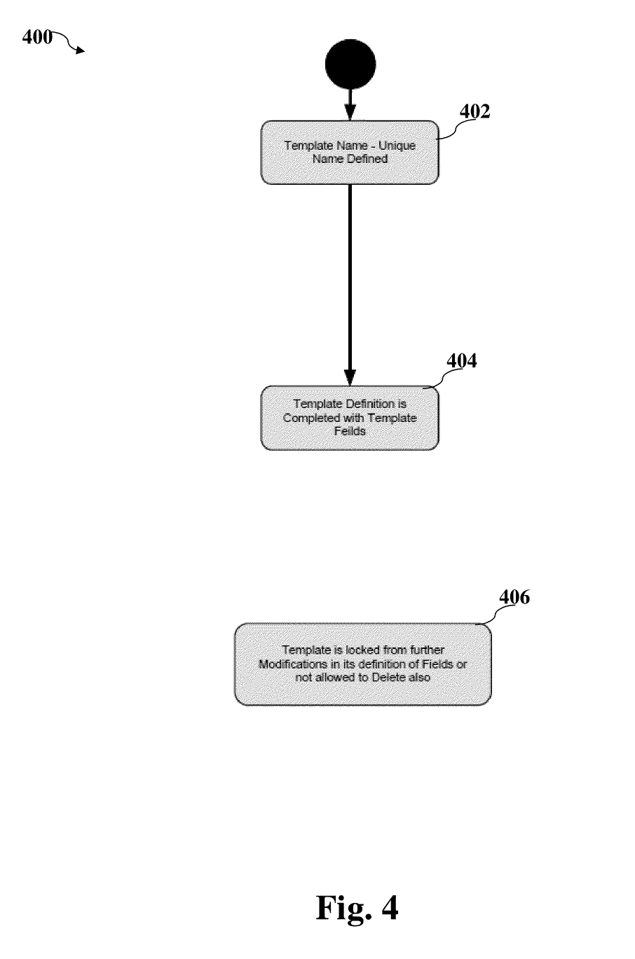

Reference is made to FIG. 4, which schematically illustrates a workflow 400 for creating a customized template according to an embodiment of the invention. The method of FIG. 4 may be executed using the devices of FIG. 1, e.g., by project manager computer 102.

Operation 402 may initiate template creation process 400 by creating a unique system entry for a template. The template may be identified by a unique identifier, such as, a name, code, link, memory address, etc.

In operation 404, the template may be customized by a user defining settings for variable template parameters, such as a template data structure, a template layout, consolidated behavior, a field data type, numeric field attributes, formula functions, formula operators, field validation rules, field input types, mandatory response fields, and/or assignment of question to group or individual responders and delegated fields.

The template parameters may be copied from a previous template (e.g., according to operation 212 of FIG. 2) or may be generated from scratch (e.g., according to operation 202 of FIG. 2).

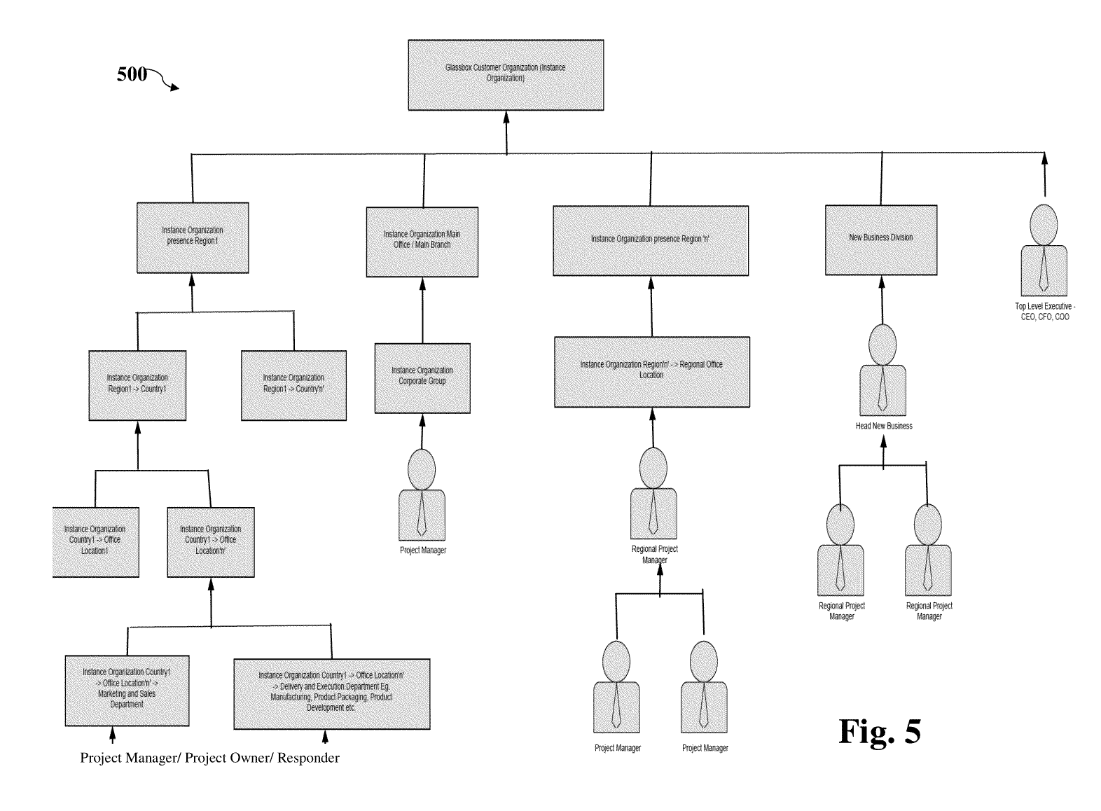

Reference is made to FIG. 5, which is a diagram showing the organization of individual responders into groups according to an embodiment of the invention. Each group may include one or more members connected, for example, by an organizational structure or task.

Data submitted by a single responder may populate each template field associated with the individual responder and any group(s) in which the responder is a member. For each group-designated assignment, the responder's data may represent the entire group's submission (e.g., if all members approve the same data entry, or if the responder is designated as a group representative) or the responder's data may be accumulated and submitted with data submitted by other group members. Accumulated member data may be evenly weighted for each group member or may be unevenly weighted for different group members, e.g., according to each group member's level or position in a group hierarchy.

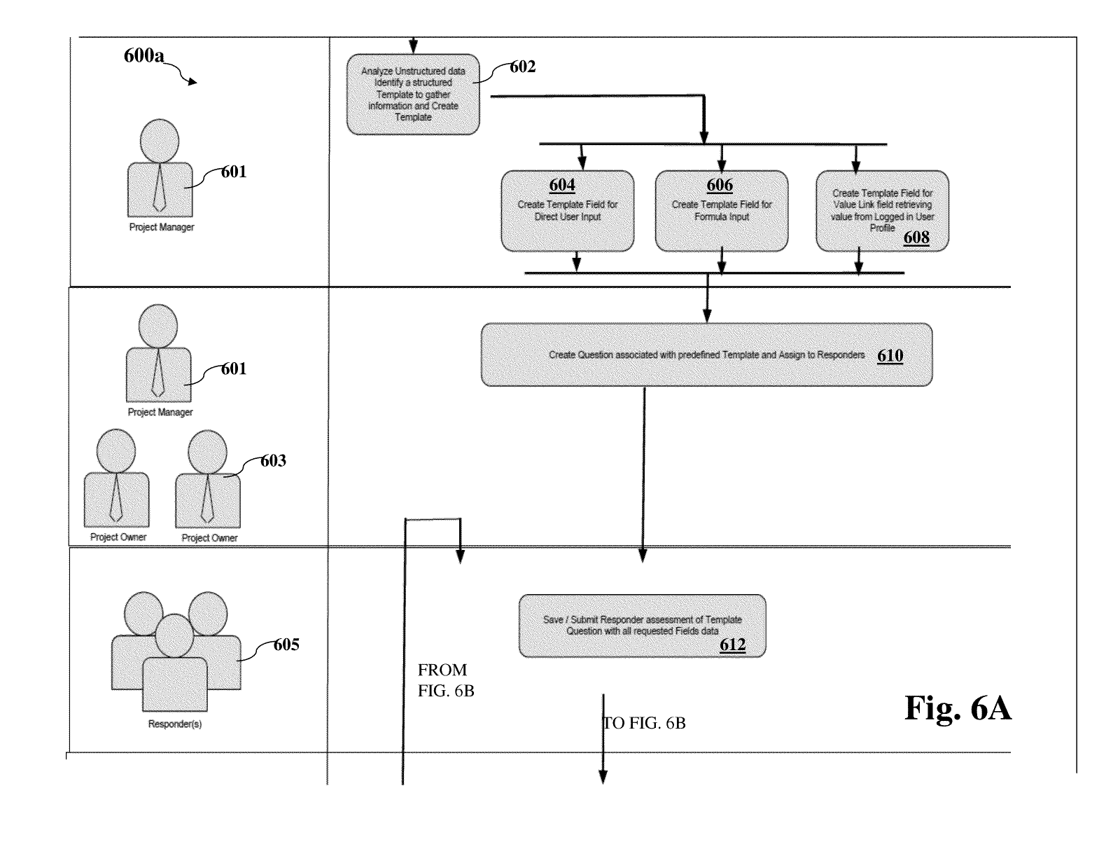

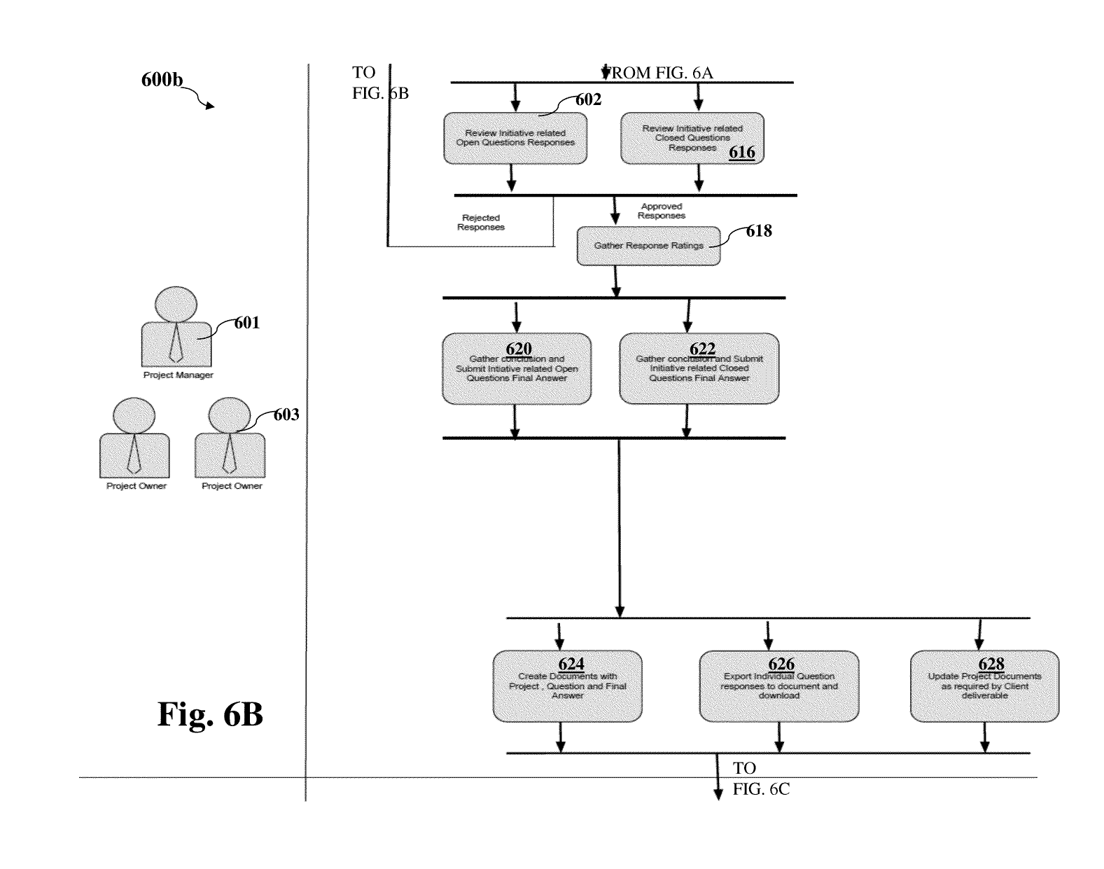

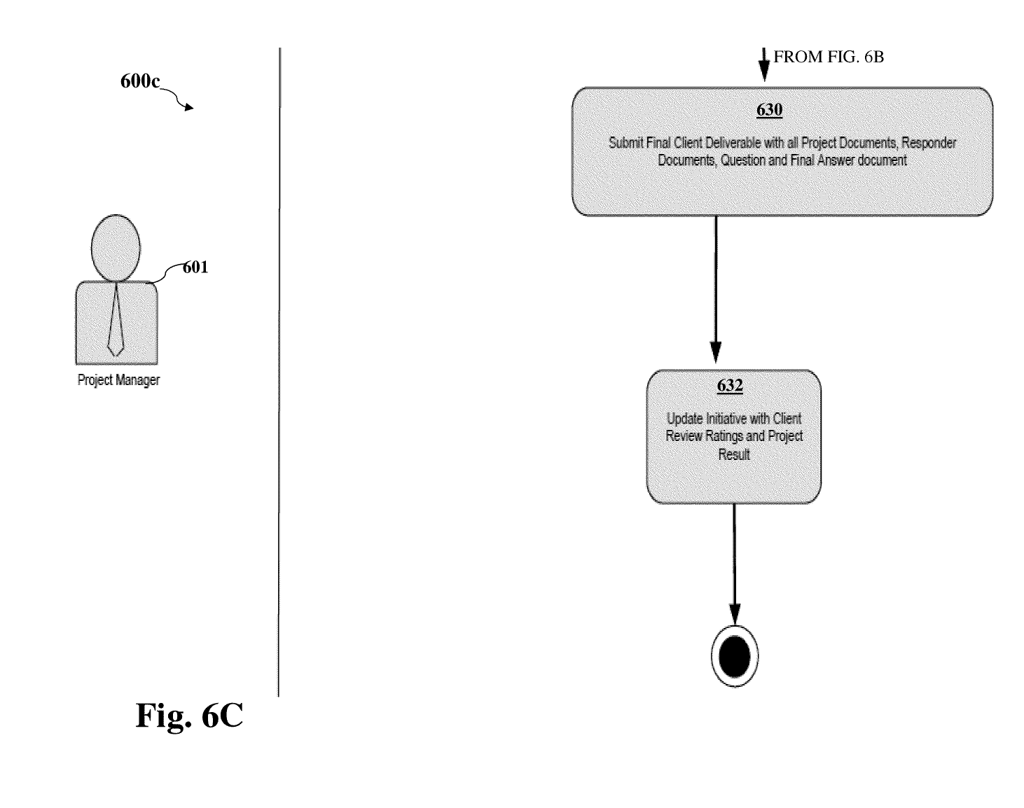

Reference is made to FIGS. 6A-6C, which schematically illustrate a workflow 600a-c for creating and using customized templates according to an embodiment of the invention. The method of FIGS. 6A-6C may be executed using the devices of FIG. 1. For example, a project manager 601 and/or project owners 603 may each operate a computer 102 of FIG. 1 and a plurality of responders 605 may each operate a computer 120 of FIG. 1 to implement workflow 600a-c. Project managers 601 and project owners 603 may have different roles, resources and privileges. For example, in one embodiment, project managers 601 have broader capabilities than project owners 603, including the ability to create as well as own projects, copy projects, create templates, and manage reports and documents. Within a project, both project manager 601 and project owners 603 may have the capabilities to assign questions, review responses, rate responses, reject responses, and delegate users.

In operation 602, a processor (e.g., server processor 116 of FIG. 1), e.g., controlled by project manager 601, may create a template to gather and analyze information submitted by responders 605.

In operations 604-608, the processor may create template fields for inputting direct user input, formula input, and/or value link input (e.g., input 306-310 of FIG. 3, respectively).

In operation 610, the processor may receive a designation from project manager 601 to associate the template to a question. The question may be assigned to one or more responders 605, where each responder 605 may include an individual or group or members.

In operation 612, the processor may receive responses to the question from assigned responders 605.

In operations 614-616, the processor may request approval of the responses from project manager 601, for example, to initiative related open-ended and/or closed-ended questions, respectively. If a response is rejected, a process may return to operation 612 to receive another response from the responder 605 that submitted the rejected response. If the response is accepted, a process may proceed to operation 618.

In operation 618, the processor may gather response ratings from project manager 601.

In operations 620-622, the processor may automatically process the approved responses and ratings to submit conclusions and final answers to the initiative related open and closed question, respectively.

In operations 624-628, the processor may populate the template with the final answers. In operation 624, the processor may generate documents including the project or template, questions and final answers. In operation 626, the processor may export individual question responses to the document to download. In operation 628, the processor may update project documents.

In operation 630, the processor may generate and submit a final client package including all project documents, responder documents and/or final answer documents.

In operation 632, the processor may update the project with client review ratings and project results.

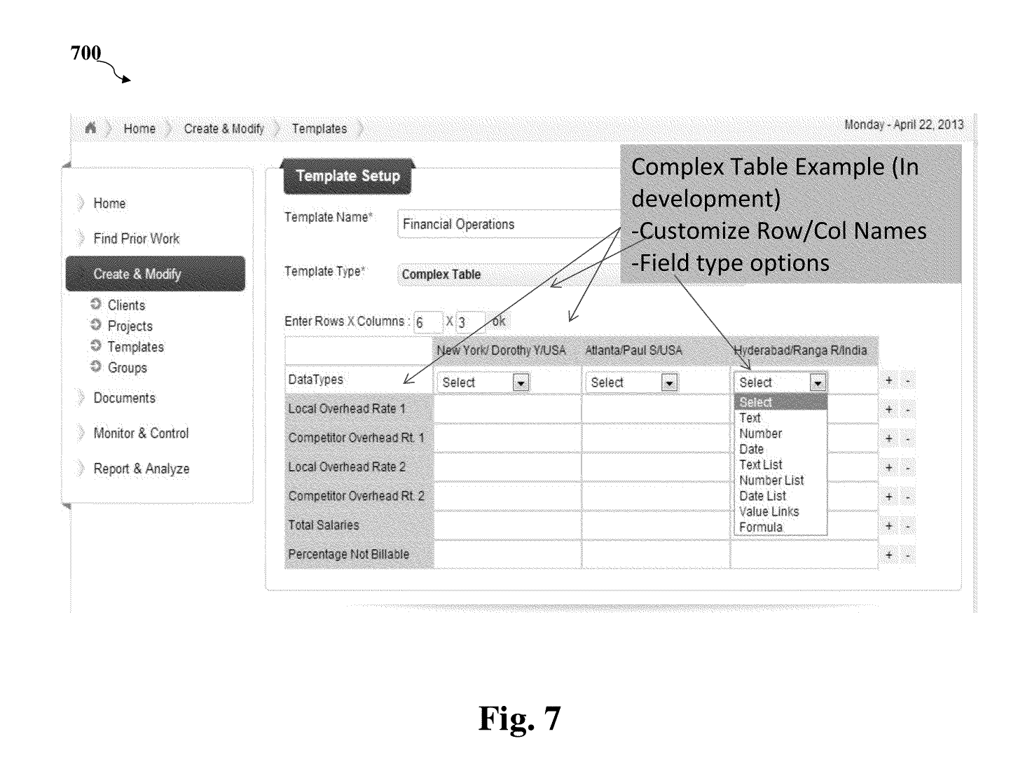

Reference is made to FIGS. 7-13, which shows example user-interfaces 700-1300 for customizing a template according to an embodiment of the invention.

In FIG. 7, a user (e.g., a project manager) may operate user-interface 700 to create a template having a table data structure. The user may initiate the template creation process by entering a unique identifier (e.g., “Financial Operations”) for the template and/or project. The user may create the customized template by selecting template parameters defining a template data structure and layout and data types for each template field. In the example of FIG. 7, the selected data structure is a two-dimensional (“complex”) table, the selected layout includes six rows and three columns, and the field data types are to be selected from among text, number, date, text list, number list, date list, value links, fixed values and formula.

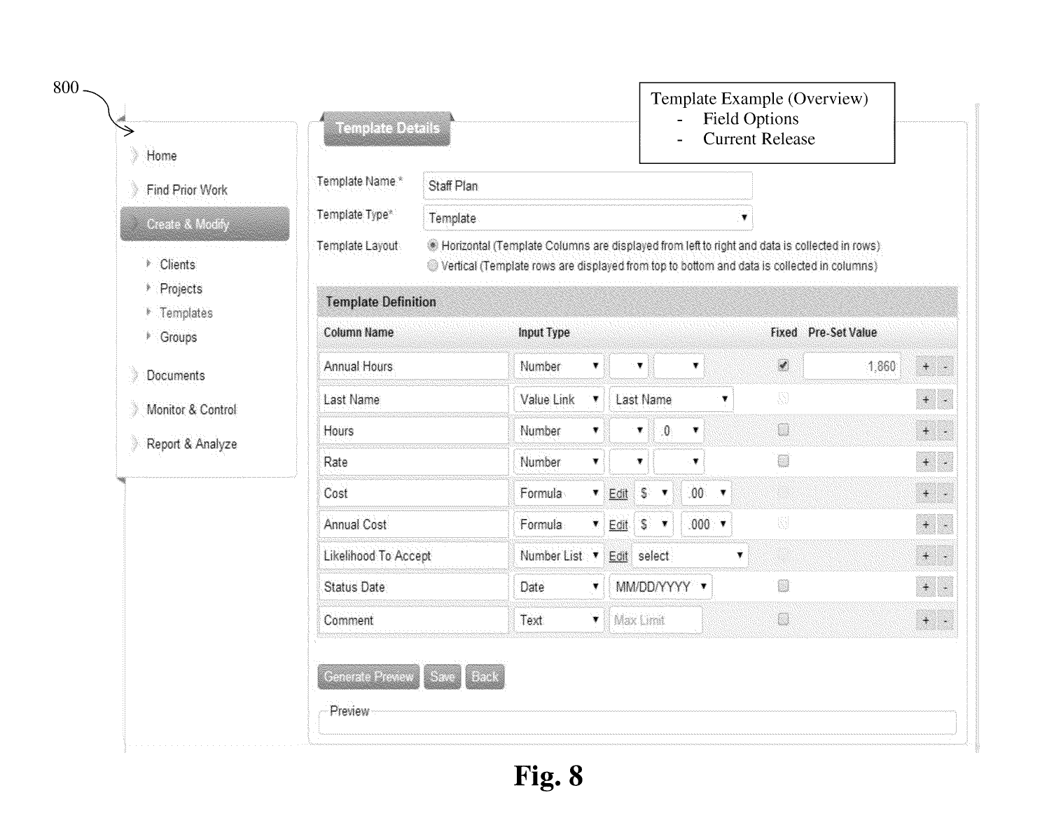

In FIG. 8, the user may operate user-interface 800 to create a template having a spreadsheet data structure. The user may assign one or more template questions to a plurality of responders, e.g., selected from among groups (e.g., office), individual responders and regions (e.g., country). The user may customize the template by selecting template parameters defining the template column/row headings, the data types (e.g., text, number, formula) for each column/row, the number of decimal places for numeric fields, a summary field defining statistical information for number fields (e.g., total, average, max, min) and functions used for formula fields (e.g., salary*hours).

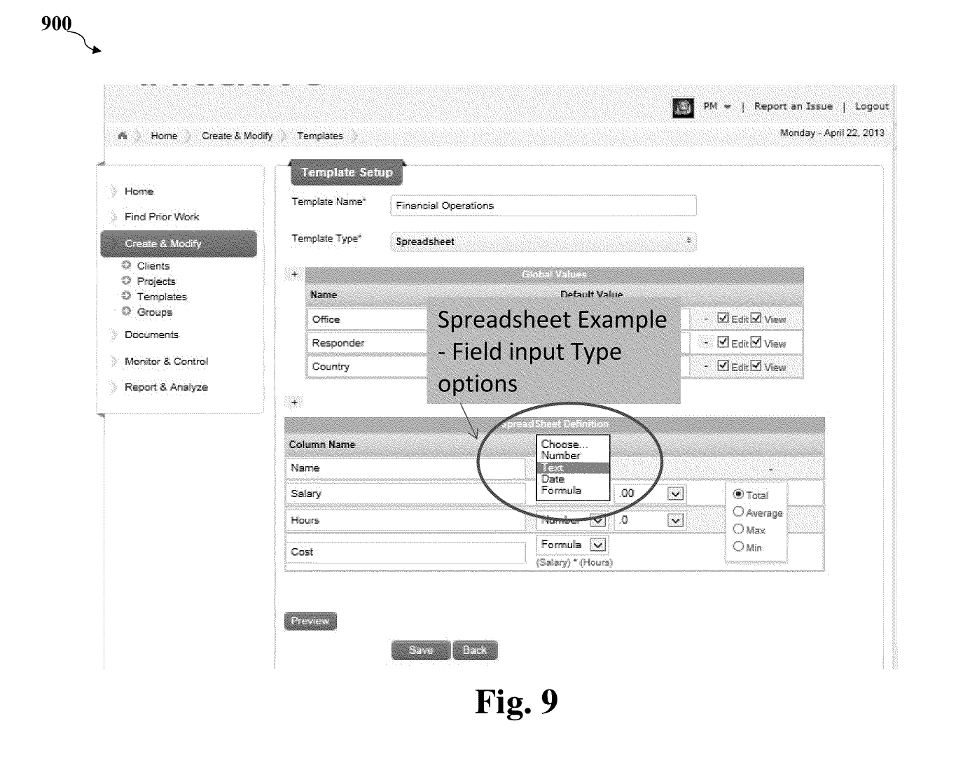

In FIG. 9, a data type is selected to be text.

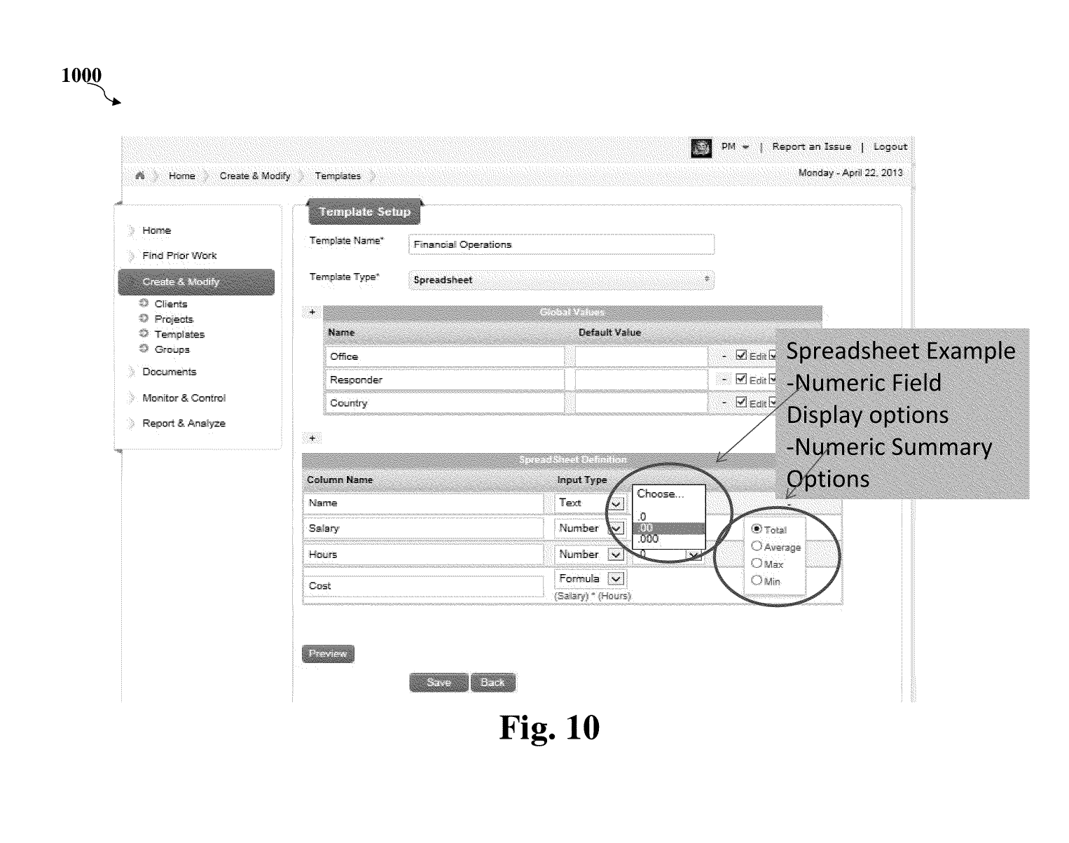

In FIG. 10, a number of decimal places is selected as two (“0.00”) and a summary field is selected as a total of numeric responses to the question.

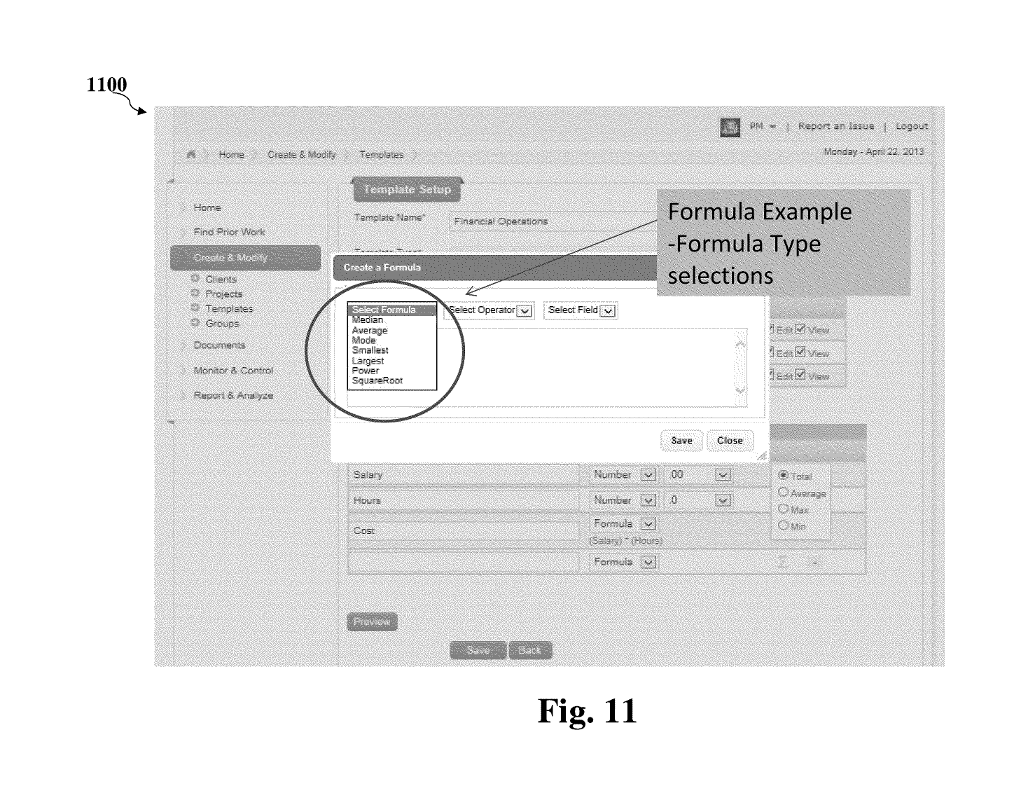

In FIG. 11, a data type is selected as formula.

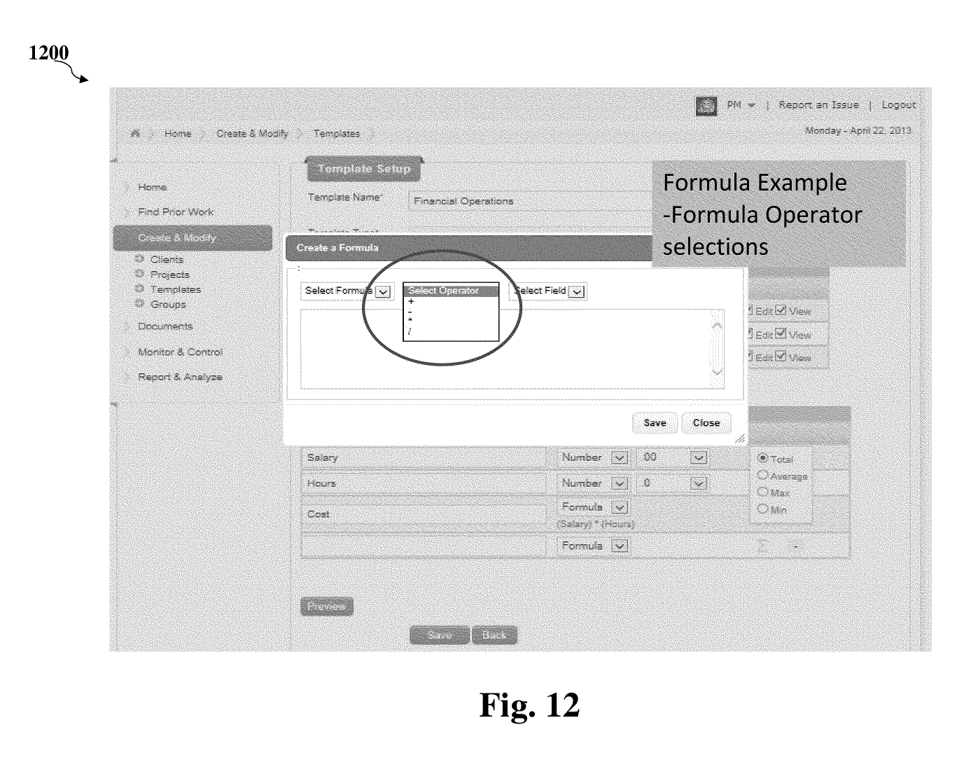

In FIG. 12, a formula operator is selected from addition, subtraction, multiplication and division.

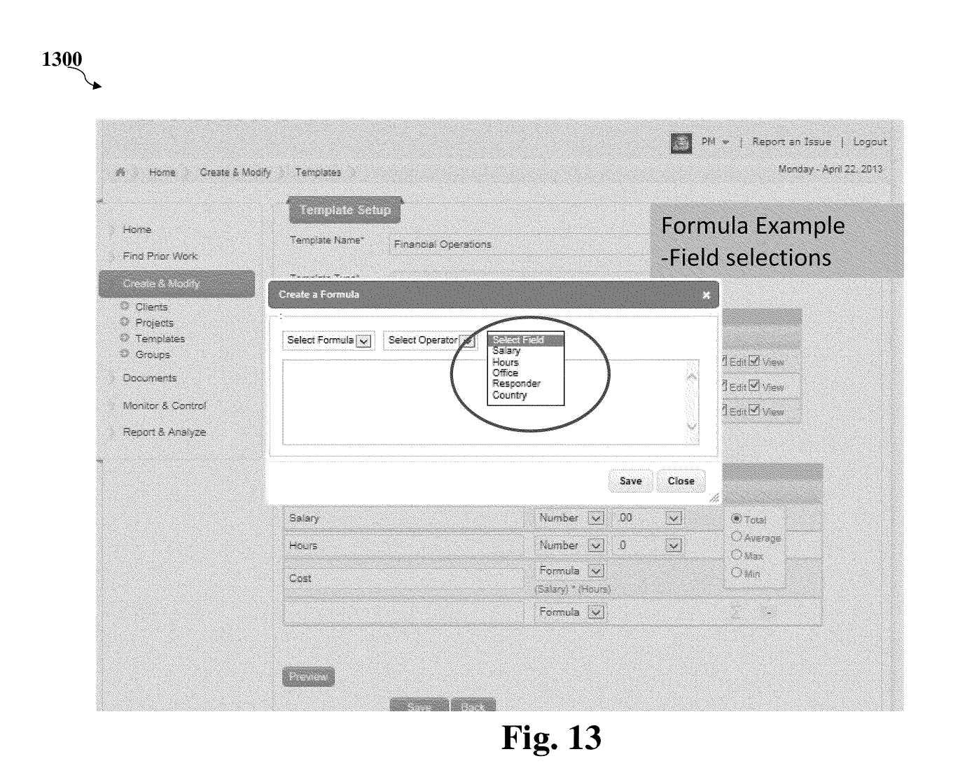

In FIG. 13, a formula function is created by selecting fields (e.g., salary, hours, etc.) to input into the formula function.

Other or different parameters may be provided and selected via user-interfaces 700-1300.

Some embodiments of the invention provide a system and method for creating a template and assigning it to the appropriate expert responder(s). The expert responder(s) complete the portion(s) of the template assigned to him or her. (The expert Responder may see only questions to which he or she is assigned.) At the end of this process, all the data provided by all the expert responders may be aggregated within the syntax of the template—order of the fields, data types of the fields. The system aggregates (“rolls up”) the data from individual responses into the template. This data is automatically formatted in the desired data structure for export to a target destination.

Some embodiments of the invention place control for aggregating responder data solely in the hands of the template creator, e.g., the project manager (at the front end). Some embodiments of the invention require the template data type metadata to comply with or match the metadata of the target system. Some embodiments of the invention align the core metadata fields in the system during the creation of templates so that the final aggregation of template data from multiple sources is delivered in a form and format that can be directly imported into the target system. Some embodiments of the invention eliminate complex level process integration.

It may be appreciated that although certain devices and functionality are assigned to “responders,” “reviewers,” “project managers,” “project owners,” “executives,” “employees,” “personnel,” etc., such functionality may be implemented by any users in any environment.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium (e.g., memories 104, 128, 124 and/or 114 of FIG. 1), such as for example a memory, a disk drive, or a USB flash memory encoding, including or storing instructions, e.g., computer-executable instructions, which when executed by a processor or controller (e.g., such as processor(s) 106, 138, 126, and/or 116 of FIG. 1), cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for customizing a template used to accumulate data from a plurality of responders, the method comprising:
generating a template customized according a plurality of Project Manager-selected template parameters including: a layout of the template indicating a number of rows and/or columns of template fields and a data type for each field selected from a plurality of data types in the group consisting of: text, number, date, text list, number list, date list, constant value, link to another field and formula;
associating each template with a question;
assigning each question to one or more responders;
receiving unstructured data from responders in response to the question;
converting the unstructured data to structured data having the data type selected for the template field(s) associated with the question; and
populating the template field with the converted structured data.

2. The method of claim 1, wherein the plurality of user-selected template parameters further includes: a template data structure, consolidated behavior, numeric field attributes, formula functions, formula operators, field validation rules, field input types, mandatory response fields, assignment of question to group or individual responders and delegated fields.

3. The method of claim 2, further comprising generating an error message if all data required for completion of a template is not entered according to the designated format.

4. The method of claim 2, further comprising saving all responder data when all errors conditions are resolved.

5. The method of claim 1, wherein the plurality of predefined data types for each field includes one or more of the following data types: text, number, date, text list, number list, date list, constant value, link to another field, formula, image and embedded table.

6. The method of claim 1, wherein the formula data type is created by defining a formula function using a formula operator to operate on selected other template fields.

7. The method of claim 1, wherein the unstructured data is non-alphanumeric data and the template is populated with the non-alphanumeric data.

8. The method of claim 1, wherein converting the unstructured data to structured data comprises performing textual analysis on the unstructured data to identify relevant data therein and converting the identified data to the data type selected for the template field(s).

9. The method of claim 1 comprising locking templates from being modified if the templates are associated with questions.

10. The method of claim 1, wherein the template is populated automatically on a rolling basis.

11. The method of claim 9, wherein the template is populated periodically according to a predefined time interval.

12. A system for customizing a template used to accumulate data from a plurality of responders comprising:
a processor configured to:
generate a template customized according a plurality of Project Manager user-selected template parameters including: a layout of the template indicating a number of rows and/or columns of template fields and a data type for each field selected from a plurality of data types in the group consisting of: text, number, date, text list, number list, date list, constant value, link to another field and formula;
associate each template field with a question;
assign each question to one or more responders;
receive unstructured data from responders in response to the question;
convert the unstructured data to structured data having the data type selected for the template field(s) associated with the question; and
populate the template field with the converted structured data.

13. A computer-readable storage medium comprising a set of instructions that when executed by a processor in a computing apparatus cause the processor to:
generate a template customized according a plurality of Project Manager user-selected template parameters including: a layout of the template indicating a number of rows and/or columns of template fields and a data type for each field selected from a plurality of data types in the group consisting of: text, number, date, text list, number list, date list, constant value, link to another field and formula;
associate each template field with a question;
assign each question to one or more responders;
receive unstructured data from responders in response to the question;
convert the unstructured data to structured data having the data type selected for the template field(s) associated with the question; and
populate the template field with the converted structured data.
